(19) United States
(12) Patent Application Publication
(10) Pub. No.: US 2008/0261820 A1
(43) Pub. Date: Oct. 23, 2008

(54) Methods to Analyze Biological Networks

(75) Inventors: Ravi Iyengar, Monhegan Lake, NY (US); Avi Ma'ayan, Englewood, NJ (US)

Correspondence Address: DARBY & DARBY P.C., P.O. BOX 770, Church Street Station, New York, NY, 10008-0770, US

(73) Assignee: Mount Sinai School of Medicine of New York University, New York, NY (US)

(21) Appl. No.: 11/997,632

(22) PCT Filed: Aug. 1, 2006
(86) PCT No.: PCT/US06/30570

§ 371 Date: Jun. 2, 2008

Related U.S. Application Data
(60) Provisional application No. 60/704,571, filed on Aug. 1, 2005.

(51) Int. Cl. C40B 30/02

(52) U.S. Cl. 506/8

(57) ABSTRACT

The present invention relates to a family of graph-theory based methods for the analysis of intracellular signaling networks created from biomedical literature using data-mining processes or acquired through high-content experiments. The methods of the present invention can be used to identify functional dynamic modules within biological networks that can be analyzed quantitatively for input/output relationships. In particular, the present invention relates to a computer-aided method for the in-silico analysis of signaling and other cellular interaction pathways to rank drug targets, identify biomarkers, predict side effects, and classify/diagnose patients.

This application claims the benefit of U.S. Provisional Application No. 60/704,571 filed Aug. 1, 2005, which is hereby incorporated by reference.

### FIELD OF THE INVENTION

The present invention relates to a computer-aided system and family of graph-theory and differential equation based methods for the analysis of intracellular signaling networks created from biomedical literature using data-mining processes or acquired through high-content experiments. The methods of the present invention can be used to identify functional dynamic modules within biological networks that can be analyzed quantitatively for input/output relationships. In particular, the present invention relates to a computer-aided system and method for the analysis of signaling and other cellular interaction pathways. Furthermore, the methods can be used to understand relationships between cell signaling pathways, identify and rank drug targets, identify biomarkers, predict side effects, and classify/diagnose patients.

### BACKGROUND OF THE INVENTION

Components within mammalian cells interact with one another to form sub-cellular local networks that come together to form a single large network. These levels of organization are essential for the various components to effectively coordinate their individual activities so as to achieve the cohesiveness needed for cellular functions. To achieve this cohesiveness, information is required to flow between the components in a continuous and organized manner. Determining how this flow of information occurs is a crucial step in understanding the functional organization of mammalian cells. To this end, the present invention provides for a mesoscale system of interacting cellular components and methods to analyze the flow of regulated connectivity between the components of the system.

It has been proposed that a mammalian cell is comprised of a central signaling network connected to various cellular machines that are responsible for phenotypic functions (Jordan, et al., Cell., 2000, 103, p. 193). Utilizing this line of reasoning allows for the development of a system wherein the various cellular machines such as transcriptional, translational, motility and secretory machineries of cells are represented as sets of interacting components that form functionally specified local networks. These local cell machine networks may then be connected to one another through a central signaling network that receives and processes signals from extracellular chemical entities such as hormones, neurotransmitters, autocrine and paracrine factors, as well as extracellular matrix proteins that inform the cell of the mechanical forces encountered. Information flow through the cell signaling pathways networks have been extensively studied both experimentally (2, 3) and theoretically (4, 5). The experimental studies have defined how different pathways interact to form networks and the information processing capabilities of networks to produce various regulatory configurations such as switches (4, 6), gates (7, 8), feedback (9, 10) and feedforward loops (11, 12) that allow for information propagation across time-scales. These approaches for defining regulatory units are essentially constructed from basic components and are valuable when only a few interacting components are considered (10). However, when the number of components in a network increases beyond a small number of interacting components, it becomes necessary to incorporate factors relating to how the network is regulated. One solution is to obtain an overview of the patterns of the regulatory motifs an other subnetwork modules within the system and define their interrelationships. This is optimally done before the individual units are analyzed in depth using quantitative biochemical representations.

The present invention utilizes graph theory analysis, a field of study focused on qualitative relationships between nodes (components) in a network. There has been substantial progress in applying graph theory approaches to biological systems (13). Several independent methods have been used to analyze the qualitative representation of networks. These include characteristic path length and measures of local density of interactions such as the clustering (14) and grid (15) coefficients. The characteristic path length denotes the average of the number of steps required for connectivity from any component to any other component in the network. The clustering and grid coefficients are measures of local connectivity and indicate the degree of interconnectedness between the neighbors of any node of interest and thus can represent the density of connections in an area within the network. Other characteristics of the network such as scalability (16) and the identification of network motifs (17) can also be used to analyze a system of interest. Such analyses have been quite valuable in understanding sub-systems within the cell such as putative metabolic networks inferred from genetic information (18) and gene regulatory networks (19).

Current analyses of these networks have largely been under the assumption that the networks are always fully connected. The present invention also uses these approaches to analyze a system wherein connectivity is dynamic. In a system, such as a signaling network, connectivity is achieved in response to a discrete stimulus which propagates through the system to obtain engagement of components responsible for cellular phenotypic functions. The present invention also identifies the regulatory features that emerge as connectivity propagates.

The present invention incorporates a family of algorithms inspired by graph-theory and useful for the analysis of mammalian intracellular regulatory networks. This method is also applicable to other biological and non-biological complex systems abstracted to networks. Experimentation with organisms, biological systems and individual cells has defined how different pathways interact to form networks and small-scale regulatory configurations such as switches, gates, feedback loops, and feedforward motifs called regulatory network motifs (Milo et al. 2002, Ma'ayan et al. 2005). Network motifs decode signal duration, signal strength and process information. From data in the experimental literature, a system of interacting cellular components involved in phenotypic behavior can be constructed where qualitative relationships between nodes (components) in a network are stored in a structured format. In signaling networks, activation is achieved as a response to a stimulus. Information propagates through the system by a series of coupled biochemical reactions to regulate components responsible for cellular phenotypic functions.

Approaches to understanding and managing networks based on complex biological systems have been described (See U.S. Pat. No. 5,930,154 for example). The present invention discloses several unique methods for biological network analysis and represents a distinct improvement over existing methods for a number of reasons. Principally, current methods of complex network analysis operate under the assumption that the network is fully connected, and where all links and nodes are functional, at all times. The present invention analyzes these systems wherein the connectivity is dynamic. In this manner, systems such as a cell signaling network, connectivity is achieved in response to a discrete stimulus. Signals propagate through the system to obtain engagement of components responsible for cellular phenotypic function. The present invention identifies regulatory features and patterns as connectivity propagates through networks.

Methods of validating therapeutic targets are well known in the art (See for example Harvey, et al., Oncogene. Aug. 7, 2003;22(32):5006-10. Use of RNA interference to validate Brk as a novel therapeutic target in breast cancer: Brk promotes breast carcinoma cell proliferation). The information required to build the interaction data set used for the methods of the present invention can come from many sources. Potential sources of information regarding interaction data needed to construct the interaction data sets include scientific literature, and high-content experimentation such as expression profiling. The interactions from the scientific literature can either be extracted by manual literature search or semi-automatically, or automatically (without the need for the network builder/user to read the articles) using different data-mining software tools such as PathwayStudio (e.g. Nikitin et al. 2003). Interactions can be assembled from existing databases containing interaction records describing direct protein-protein or ligand-protein interactions. It is important that these interactions are both direct and functionally relevant and it is recommended that the interactions are verified by a peer review process to ensure quality. When integrating external interaction data sources it is important to filter those datasets for quality. Links in the interaction networks may be activating, inhibitory or neutral. Neutral links do not specify directionality between components, and are mostly used to represent scaffolding and anchoring interactions, bidirectional interactions, or interactions without no clear source and target. The biochemical specification of the interaction between two molecules includes defining the reactions as non-covalent binding interactions or enzymatic reactions. Within the enzymatic category, reactions should be further specified as phosphorylation, dephosphorylation, hydrolysis, etc. These two criteria for specification are independent and should be defined for all interactions although not required for the application of the analysis methods described in following embodiments.

Chosen research articles for manually constructing networks should demonstrate direct interactions that were supported by either biochemical or physiological effects of the interactions. It is also possible to use networks created by other methods such as high- throughput experiments (e.g. high throughput yeast-2-hybrid methods [Rual et al. 2005]). The compatibility of the templates with other previously proposed templates makes it available for exchange (import/export) and there is no claim that the described templates or method for building such networks are novel. See FIG. 2 for a flow-chart summarizing of the different approaches that can be taken in creating such networks.

The graph theory based algorithms employed in this invention have not previously been employed in biological signaling networks. These algorithms are disclosed in Thomas H. Cormen, Charles E. Leiserson, Ronald L. Rivest, and Clifford Stein. Introduction to Algorithms, Second Edition. MIT Press and McGraw-Hill, 2001. ISBN 0262032937. Section 22.3: Depth-first search, pp. 540-549. In other words, subnetworks are rather “discovered” by the graph theory based algorithm. To generate these subnetworks a depth-first search algorithm (See U.S. Pat. No. 7,079,943 for example) and is generally explained in Cormen et al. 2001, can be used with specific implementation, as described later in this document, to expand interactions based on directionality and distance in steps from input nodes representing receptors activated by specific ligands. Counts of feedback loops, feed-forward loops, bifans, and scaffolding regulatory network motifs and other network motifs can also be identified. For a definition of these motifs refer to Ma'ayan et al. 2005. Additionally, identified positive feedback loops can be compared to the identified negative feedback loops found in subnetworks in each step and those counts compared to counts found in shuffled networks or counts created using combinatorial statistics. The network motifs and subnetworks identified can be then analyzed using qualitative analysis approaches such as differential equation modeling-based approaches (Bhalla and Iyengar, 1999). As an example, propagation of connectivity and network motifs appearance resulting from interactions of twenty-three extraceliular ligands to their receptors was analyzed for the neuronal regulatory network described in (Ma'ayan et al. 2005).

Identified network motifs and subnetworks can be analyzed using qualitative analysis approaches such as differential equation modeling-based approaches (Bhalla and Iyengar, 1999). As an example, propagation of connectivity and network motifs appearance resulting from interactions of twenty-three extracellular ligands to their receptors was analyzed for the neuronal regulatory network described in (Ma'ayan et al. 2005).

Feedback loops and all other types of network motifs are identified in this invention using an original method. Other systems that find and compute the statistical significance of network motifs and subgraphs using different computational methods exist, for example, the MFinder program developed (Kashtan, et al 2004) Efficient sampling algorithm for estimating subgraph concentrations and detecting network motifs. Bioinformatics 20, 1746-1758.). The method in this application recursively expands nodes in the neighborhood of the current node and searches this way until a loop, a target node, or a limited depth was found or reached. A pseudo-code of the implementation of such an algorithm is described in the embodiments below. The code could be easily modified by a person skilled in the art for identifying subnetworks from sources to targets, cycles with Euclidian distance restriction, and any other type of network motif (Kashtan N., Itzkovitz S., Milo R., Alon U. (2004) Efficient sampling algorithm for estimating subgraph concentrations and detecting network motifs. Bioinformatics 20, 1746-1758.). The disclosure of all of the patent and literature references mentioned in this publication is hereby incorporated by reference.

### SUMMARY OF THE INVENTION

The present invention provides a method for identifying and ranking new drug targets for a known drug from an interaction data set by a) collecting a plurality of information units, each of said units containing biochemical data describing an interaction between two interacting molecules, b) constructing an interaction data set from said collected information units, in which each of said molecules represents a node and said interaction between said interacting molecules represents a link between two nodes, c) storing the interaction data set in an extractable form, d) selecting from the interaction data set a list of nodes shown to be altered in a cell upon treatment with said known drug as an algorithmic starting point, e) applying one or more graph theory based algorithms to the interaction data set using each node in the selected list of nodes as a starting point to identify a new list of nodes which connected to each node in the selected list, through any number of interconnected nodes, f) compiling the number of instances in which each node appears in the new list of nodes, and g) selecting as drug targets those molecules corresponding to nodes with the highest number of instances.

In one preferred embodiment a list of algorithmic starting points is created by i) obtaining experimental data from an experiment where the known drug was administered, ii) obtaining experimental data from an experiment where the known drug was not administered, and iii) creating a list of biomolecules that have an observable change when comparing the results of the experiment in step (i) with the experiment in step (ii).

In another preferred embodiment the information units are obtained from published literature.

In another preferred embodiment the information units are collected from experimental data.

In yet another preferred embodiment at least one visual or textual representation of the interaction data is generated for the list of nodes derived from the algorithmic analysis.

In another preferred embodiment the interaction data set comprises interactions from a cellular signal transduction pathway.

In yet another preferred embodiment the interaction data set comprises interactions from a cellular metabolic pathway.

In another preferred embodiment the interacting molecules comprise peptides, proteins or nucleic acids.

In another preferred embodiment the list of nodes connected to the selected node is a list of potential non-therapeutic targets of said known drug.

In another preferred embodiment the non-therapeutic target is a side-effect of the known drug.

In another preferred embodiment the interaction data set is stored on a computer.

In another preferred embodiment generating the visual or textual representations of the connectivity data are generated on a computer.

In other preferred embodiment the graph theory based algorithm is performed on a computer.

In a particularly preferred embodiment the graph theory based algorithm is a depth-first search algorithm.

The present invention also provides for a method for screening to find potential new drug targets for a known drug using an interaction data set by a) collecting a plurality of information units, each of said units containing biochemical data describing an interaction between two interacting molecules, b) constructing an interaction data set from said collected information units, in which each of said molecules represents a node and said interaction between said interacting molecules represents a link between two nodes, c) storing the interaction data set in an extractable form, d) selecting from the information data set a node known to interact with said known drug as an algorithmic starting point, e) applying one or more graph theory based algorithms to the interaction data set using the selected node as a starting point to identify a list of nodes connected to the selected node, through any number of interconnected nodes, and f) comparing the number of interconnected nodes between the input node and each node from the list of nodes. g) selecting as potential new drug targets those nodes having the lowest number of interconnected nodes.

In one preferred embodiment the information units are collected from published literature.

In another preferred embodiment the information units are collected from experimental data.

In still another preferred embodiment at least one visual or textual representation of the interaction data is generated for the list of nodes derived from the algorithmic analysis.

In another preferred embodiment the interaction data set comprises interactions from a cellular signal transduction pathway.

In another preferred embodiment the interaction data set comprises interactions from a cellular metabolic pathway.

In still another preferred embodiment the interacting molecules comprise peptides, proteins or nucleic acids.

In further preferred embodiment the list of nodes connected to the selected node is a list of potential non-therapeutic targets of said known drug.

In yet another preferred embodiment the non-therapeutic target is a side-effect of the known drug.

In a further embodiment the interaction data set is stored on a computer.

In another preferred embodiment generating visual or textual representations of the connectivity data is performed on a computer.

In another preferred embodiment the graph theory based algorithm is performed on a computer.

In particularly preferred embodiments the graph theory based algorithm is a depth-first search algorithm.

### BRIEF DESCRIPTION OF THE DRAWINGS

FIG. 1. A graphical representation of a sample network created from biomedical literature as described in (Ma'ayan et. al. 2005). The data is visualized by placing nodes as triangles within their functional compartments. The size of triangle demonstrates its level of connectivity for the node. Links are represented by arrows. All of the interaction depicted in this graphical representation are direct biochemical interactions.

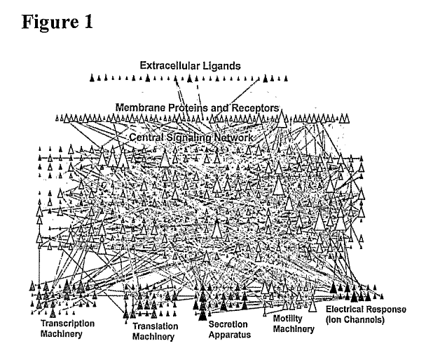

FIG. 2. A flow-chart summarizing of the different approaches that can be taken in creating an interaction data set to be used for analysis by the graph-theory based methods.

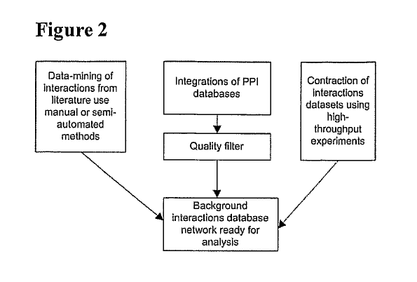

FIG. 3. Output from a graph theory based analysis creating subnetworks in steps. The total number of links accumulated as a signal moves through the steps, as shown for various ligands.

FIG. 4. A graphical representation of a single subnetwork created from the selected (or source) node (S) to a target node (T).

FIG. 5. Graphical output representing a network connecting the extracellular drug HU through its target CB1R to 200 transcription factors (TFs).

FIG. 6. An outline describing a general method for identifying a list of regulating components produced by high-content experiments.

FIG. 7. An outline of the general process describing the methods in this application. Steps depicted as rectangles with lines on both sides involve in a method that can lead to identification of drug targets, biomarkers, side effects and improve diagnosis.

FIG. 8. The density of information processing (DIP) profile per step, plotted for the three different molecules taken through eight steps.

FIG. 9. Five motif location index (MLI) maps corresponding to five different cellular machines: transcription, translation, secretion channels and motility.

### DETAILED DESCRIPTION OF THE INVENTION

The invention provides novel methods which can be used for identifying and ranking drug targets and for predicting side-effects of drug candidates. The invention also provides for novel methods which can be used for analysis of signaling pathways. In particular, the methods of the invention utilize and integrate graph-theory based analysis. This invention provides for the first time graph theory dynamics and network analysis applied to drug discovery.

The present invention further provides a family of related computational methods that can be used to identify and rank drug targets, and predict side effects, using a family of related graph-theory based methods. Furthermore, the invention describes methods to parallelize the computation and optimize the methods so their implementation can be utilized using cluster platforms. Cell signaling pathways can be represented as directed and mixed (directed/undirected) graphs, hence forming a network of interacting nodes and links. In cellular networks, nodes represent bio-molecules and links represent their direct interactions. The known interactions and components experimentally discovered composing signaling networks are assembled to form in silico, large-scale, “network” datasets that are analyzed using the methods outlined in this patent application.

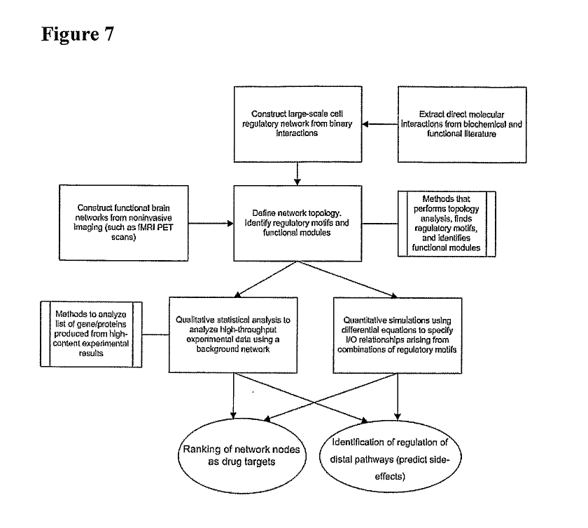

A General Description of the Method. The method described herein is composed of integrated processes that use graph theory based algorithms that are well known to those skilled in the art to create and analyze network models based on complex systems theory. The inventor can improve current approaches for the identification of drug targets, biomarkers, side effects and improve diagnosis of disease. A flowchart outlining the method is shown schematically in a FIG. 7 and described below.

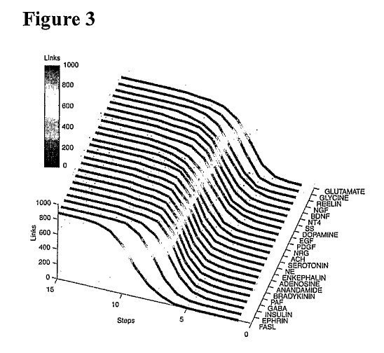

1. Construction of the interaction data set. The first step for each implementation of the method of the invention involves the construction of what is called a interaction data set. The set is constructed from a knowledge-base of a large body of interactions, with minimal information required about the details of individual interactions. The knowledge base can be published articles or the results of high-content experiments such as expression profiling or microarrays. These interactions represent an abstraction of the direct relationships between components in complex biological systems and are the dataset from which the graph theory algorithms extract connectivity data and features. A schematic outline of the steps involved in constructing the interaction data set is shown in FIG. 3.

The first step involves the identification of binary interactions between two entities. In signal transduction pathways, the entities would be two interacting proteins for example. Each interacting entity is defined as node and the interaction between the two can be given one or more sets of descriptors. An example of descriptors for a signal; transduction pathway might be the nature of the interaction (inhibition or activation). Even the strength of the interaction (binding constant) or a time-dependent variable such as the kinetics of the interaction could be used as descriptive information in the interaction data set.

The interaction data is stored as the interaction data set in a record format and in a form that can be accessed by an algorithm. In a preferred embodiment the data would be stored and the algorithm would be performed with a computer. A detailed description of building the interaction data set is described below in Example 1 in the section on data storage format and network construction. Potential sources of information regarding interaction data include the scientific literature and high content experimentation such as expression profiling or microarray.

2. Selecting an input node. The graph theory based algorithms used in the methods of this invention act on the interaction data set as any algorithm would act on a dataset and comprise functions that minimally require the selection of an input node. In some embodiments, the method requires the selection of both an input and an output mode. Selection of an input node is a required function of the method and defines the staring point of the graph theory algorithm. One example of an input node selection would be the designation of a node representing the known target of a drug whose pathway is being evaluated for additional targets. In this manner, the starting point of the algorithm is the node representing the protein that is known to be modulated by the drug. These algorithms are well known to those skilled in the art and are disclosed for example in Thomas H. Cormen, Charles E. Leiserson, Ronald L. Rivest, and Clifford Stein. Introduction to Algorithms, Second Edition. MIT Press and McGraw-Hill, 2001. ISBN 0262032937. Section 22.3: Depth-first search, pp. 540-549.
3. Optional incorporation of experimental data. In many embodiments of the method of this invention, particularly those that incorporate the selection of both an input and an output node, additional experimental data is incorporated. For example, the node representing a protein that is modulated by a drug of interest may be selected as an input node, while the node representing a protein known to be upregulated or downregulated by the treatment of a cell with the drug may be selected as output or input nodes. This selected node is used an algorithmic starting point and potential targets are identified by locating nodes that interconnect the input and/or output nodes (subnetworks or functional network motifs). In this example, the selection of the input node is based on an interest in a particular drug and the selection of the output node is based on additional experimental details regarding that drug. Examples of additional experimental data that would feed this type of embodiment include the results of high-content experiments such as expression profiling or microarray nucleotide chip experiments. For example, treating cells with different drugs as described in an embodiment below. These experiments measure high-throughput changes in activity levels or changes in quantity observed for intracellular components or other network components. This list is parsed into two (or more) clusters and lists of components shown to be changing are isolated for further analysis.
4. Optional selection of an output node. The interaction data sets constructed in the first step are then used with the lists of components produced by the experiments, and the various additional methods described in the embodiments below, to identify components and pathways not measured experimentally, or not shown to be changing experimentally, but predicted to play a pivotal role in the modulation and regulation of the components that changed in either activity or quantity.
5. Implementing the graph theory based algorithms. Graph theory based algorithms that are well known to those skilled in the art are then applied to the interaction data sets to identify either nodes that have interactions with the selected input node, or in cases where both input and output nodes have been selected, the algorithm identifies nodes that interconnect the input node with the output node. These interacting or intervening nodes are referred to as a functional network motifs or subnetworks. The network motifs and subnetworks identified by these algorithms can then be analyzed either visually or using qualitative analysis approaches such as well described differential equation modeling-based approaches. Suitable graph theory algorithms for use in prosecuting the present invention are disclosed in Thomas H. Cormen, Charles E. Leiserson, Ronald L. Rivest, and Clifford Stein. Introduction to Algorithms, Second Edition. MIT Press and McGraw-Hill, 2001. ISBN 0262032937. Section 22.3: Depth-first search, pp. 540-549. A preferred algorithm is a depth-first search algorithm.
6. Identification of drug targets and interacting pathways. The network motifs or subnetworks identified using the graph theory based approaches provide nodes that either interact with a given input node or interconnect a given input node to a given output node. In this manner, any node within the identified network motif or subnetwork, or any network motif or subnetwork that represents a known pathway, has a potential interaction with the input node. In a case where the input node is modulated by a drug, the nodes within the identified network motif or subnetwork each represent potential therapeutic or non-therapeutic targets.

### EXAMPLE 1

### Identifying Therapeutic Drug Targets

This embodiment describes an example for the use of a series of graph-theory based dynamical analysis methods applied to intracellular regulatory networks created from sparse research articles or created from other network construction methods. In this embodiment the method is used to identify potential therapeutic drug targets. The general steps involved in the method have been outlined above. The specific steps involved in creating a interaction data set, implementing the graph theory based algorithms and identifying drug targets is set forth below.

Data storage format and network construction. The data format required for the use of the graph-theory analysis methods and the process of developing in-silico network datasets from complex biological systems is presented here. This method is similar to what is required in the implementation of any method of this invention and can be utilized in many of the embodiments described below. The data format used to store networks of interacting components in complex biological systems is an abstraction of the complex biological systems into a simplified network format comprised of nodes and links: formally directed-graphs or mixed-graphs made of vertices (nodes) connected through edges (links). Mixed-graphs are networks containing both directed links, undirected links and/or bidirectional links. In order for the graph-theory inspired analysis methods described in this application to be utilized, interaction data making up the intracellular regulatory networks must be first generated and stored in a structured format template that can be accessed by the graph theory based algorithms.

For intracellular regulatory networks, the interaction data set is created by extracting interactions from the scientific literature, or experimentation, and input into a template form called a database record or schema. For example, components of signaling pathways and cellular machines and their binary interactions can be extracted into this type of interaction record. Intracellular regulatory networks datasets making up what is referred to as the interaction data set, and describing cell signaling pathways, cellular machines, or gene regulatory networks, can be stored in one type of database record (template or schema) containing the minimal following four fields:
A) Source Gene Name or Accession Code: cellular component that is affecting a target component (name must be official gene symbol or accession code).
B) Target Gene Name or Accession Code: cellular component that is affected by the source component (name must be official gene symbol or accession code).
C) Effect: activation (+), inhibition (−), or neutral (0).
D) Type of interaction: type of biochemical interaction linking the two components (i.e. phosphorylation, binding etc.).
E) PubMED ID: also called NLM's ID and is defined in the PubMed Overview at: http://www.ncbi.nlm.nih.gov/entrez/query/static/overview.html and provides a reference to the source of the interaction identification.

The examples below exemplify the content of two such records:

### Format: A/B/C/D/E

### PKCZETA/IKKB/+/Phosphorylation/10022904

### MEKK1/IKBA/−/Phosphorylation/9689078

The network data files for the intracellular regulatory networks can be stored in XML, relational databases, Object-orient databases or any other format such as plain text files. More attributes can be added to components and interactions. Only the minimal required information is listed in the examples provided above. This minimal information is the required information needed to perform the analysis described herein in the next embodiments.

Identification of a drug targets, which cause therapeutic drug effects or non-therapeutic drug effects including side-effects, are made by propagation of signals from an input node. A drug target is commonly defined as a cellular component that is modulated by a drug. In many instances a drug is a small molecule ligand, however, a drug could be any intracellular or extracellular effector. For example an antibody, hormone, or siRNA or RNAi molecule would be examples of drugs. In this embodiment, the target of the drug to be evaluated is identified based upon a known interaction. For example, a small molecule known to interact with a particular G-protein coupled receptor has a known receptor. However, there may be multiple additional downstream targets that are affected by the activation of this receptor. By applying the method of this invention, constructing a interaction data set that represents known cellular signaling pathways and graph theory based algorithms to define functional motifs, or subnetworks that might otherwise remain obscure, novel targets, which may cause either therapeutic, non-therapeutic or side-effects, can be identified.

Once the input node (representing the drug receptor designated to be analyzed) is selected, the graph theory based algorithm accesses the interconnectivity data in the interaction data set and counts nodes, links and network motifs as connectivity in discreet steps. Each step represents direct interactions between components (nodes) such that subnetworks are created downstream from input node and a subnetwork is created for each input node (e.g. ligand) at each step. One graph theory based algorithm that can be employed to generate these subnetworks is a depth-first search algorithm. This algorithm is well described and can be used with specific implementation to expand interactions based on directionality and distance in steps from the input node. Counts of feedback loops, feed-forward loops, bifans, and scaffolding regulatory network motifs and other network motifs can be identified. Additionally, identified positive feedback loops can be compared to the identified negative feedback loops found in subnetworks in each step and those counts compared to counts found in shuffled networks or counts created using combinatorial statistics.

In order to identify the potential drug target or targets, the connectivity data (the nodes and connections representing the functional network or subnetwork) can be output in a visual or textual manner and manually inspected for the existence of nodes (representing proteins) not normally known to be modulated by the drug being evaluated. Conversely, the network motifs and subnetworks can also be analyzed using qualitative analysis approaches such as differential equation modeling-based approaches. Once novel targets, causing either therapeutic, non-therapeutic or side-effects are identified, additional experiments, such as siRNA or RNAi based target validation can be implemented to validate the predicted target.

An important benefit of identifying additional targets, even targets along a known pathway, is that these targets may potentially have fewer unwanted effects that often lead to unwanted side-effects. In addition, analysis of novel functional motifs, or subnetworks may serve to elucidate pathways that are know to induce unwanted side effects and therefore be avoidable. In this manner the method of the invention may be used to screen novel drug candidates. In still a third use, the identification of additional targets may serve to identify targets that confer therapeutic effects not originally known to be ascribed to the drug being evaluated.

### EXAMPLE 2

Construction and Analysis of Subnetworks from Source to Target

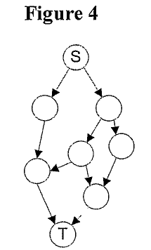

In another embodiment, a second graph-theory inspired method is described. Using this method, a series of subnetworks from specific source nodes or input nodes are created where the method identifies pathways that can reach specific target nodes with limited maximum path lengths from the source to the target that are allowed to be included for the subnetworks to be created. See FIG. 4 for an example. To generate these subnetworks a depth-first search algorithm (e.g., U.S. Pat. No. 7,079,943, Cormen et al. 2001) can be used to expand interactions based on directionality and distance in steps from the source node to the target node. The application of this method needs to ensure that all links between intermediates are added to the subnetwork after all initial paths were identified. Additionally, shuffled networks, where only the links that do not involve the source nodes and target nodes, can be created by shuffling the directionality of interactions but keeping the exact connectivity. These shuffled subnetwork are generated for statistical control by comparing network properties in these networks to the originally created subnetwork before shuffling. Positive and negative feedback loops and other regulatory network motifs in subnetworks created from the interaction data set can be compared to counts of positive and negative feedback loops and other regulatory network motifs found in the shuffled “control” subnetworks. See Ma'ayan et al. 2005 for an implementation example of this concept. Such identified subnetworks can be used to as an initial connectivity map required for transitioning to building quantitative models that can further investigate quantitative input/output relationship between source and target nodes in biological regulatory networks. These can be then analyzed using qualitative analysis approaches such as differential equation modeling-based approaches (Bhalla and Iyengar, 1999).

### EXAMPLE 3

### Construction and Analysis of Subnetworks Based on Connectivity Degree

In this embodiment, a method to create a series of subnetworks created based on nodal connectivity degree, where nodes are included in subnetworks based on nodes' average connectivity (k) is described. Here, subnetworks are analyzed for their abundance of nodes and links, characteristic path-lengths and clustering coefficients (Watts and Strogatz, 1998), number of islands, feedback loops, feed-forward loops, scaffolds, and bifan and other regulatory network motifs. To implement this method first a threshold connectivity degree needs to be determined, then all nodes with overall connectivity degree below the threshold are flagged. Only interactions between flagged nodes are included in the subnetwork. This analysis shows how some of the regulatory network motifs (i.e. feedback loops) are highly dependent on specific highly connected nodes. Formation of such regulatory network motifs may be critical for information processing of signals.

### EXAMPLE 4

### Analysis of the Significance of Activated Transcription Factors

In this embodiment, three methods that combined graph-theory inspired methods for analysis of large complex biological regulatory intracellular networks with the analysis of high-content experiments are presented. The methods specifically combine bio-molecular interaction regulatory networks created from research article biomedical literature or from other sources as described in the first embodiment where these interaction networks are used as a background to analyze the high-content experimental results that compare treated vs. untreated cells. Comparing quantities of proteins, protein-DNA interactions (U.S. Pat. No. 6,924,113, U.S. Pat. No. 6,821,737), and MRNA levels (e.g. U.S. Pat. No. 6,816,867) in cells treated with a drug or through any other type of stimulation or perturbation vs. non-treated (e.g. after serum starvation) used for experimental control is a common method used to understand drug effects on living cells or any other type of external or internal perturbation actions and effects of living cells (e.g. U.S. Pat. No. 6,859,735, U.S. Pat. No. 6,461,807). High-content experiments often produce lists of proteins, genes, list of mRNA molecules (e.g. U.S. Pat. No. 6,203,987) or other bio-molecules that were shown to be changed in quantity (either increased or decreased compared to the control) or their activity level after stimulus (e.g. drug administration) either increased or decrease in comparison to the behavior observed for these components in the control non-stimulated or mock stimulated cells. The methods herein describe how these lists can be further analyzed using unique graph-theory inspired methods. These methods are closely related to the methods described in previous embodiments. In contrast to prior patent applications (e.g. U.S. Pat. No. 6,996,476, U.S. Pat. No. 6,453,241, U.S. Pat. No. 7,054,755, U.S. Pat. No. 7,020,561, U.S. Pat. No. 5,657,255, U.S. Pat. No. 6,132,969, U.S. Pat. No. 6,821,737), this application use graph-theory inspired approaches and methods and the combination of a literature-based interaction data sets or other type of interaction data sets for the analysis.

### METHOD A

In the drug or input to the cells is known it is possible to connect this input node in the network to output nodes which are the list of components that were shown to be changed in the high-content experiments. Creating subnetworks from the source/input (drug direct target [i.e. cell surface receptor]) to the target (component that was shown to change in activity) and then counting intermediate components that are enriched in those subnetworks and pathways. The counts of those intermediates are compared with components counted in control subnetworks. Control subnetworks are created from the input node to a list of components that where shown not to be affected by the stimulation (shown to display the same behavior with or without the stimulation or the drug). The method is an extension of the method described under “Construction and analysis of subnetworks from source to target” where subnetworks are created from the input node (drug target) to reach the list of components that was created/produced from the high-content experiments. The subnetworks are created based on minimal number of steps from the source to the targets. These subnetworks are compared to identify statistically over-selected intermediate components. The statistical significance is computed as by comparing counts in subnetworks to the list of gene/proteins/mRNA that were shown to change in activity (based on the experiments) to their average occurrence (counts) in control subnetworks (these are created from the source/input node to equivalent components that did not show change in activity based on the experiments). The appropriate statistical test should be determined based on the sample size and interaction data set size. Some appropriate tests include Z-test, T-test, Fisher exact text or other contingency table statistics (the results can be constructed in a 2×2 contingency table). Different statistical tests may rank intermediate components differently and there is no claim that one of those tests provides better prediction of the involvement of components in regulation of the components from the experiments.

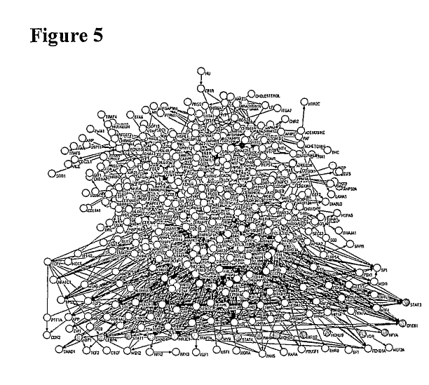

For example, this approach can be used to analyze Panomics TFs arrays experimental data results (U.S. Pat. No. 6,924,113, U.S. Pat. No. 6,821,737, Li et al. 2006). The method takes in a list of consensus sequences that are on the transcription factor arrays (e.g. as provided by the TranSignal product from Panomics Inc.) and a list of consensus sequences that showed enhance activity after cell stimulation (compare to a control experiment and with/without RNAi or pharmacological inhibitors, for example). The method also uses as an input a interaction data set as described in the embodiment above. The method outputs a list of intermediate proteins that are most likely to be involved in the cell signaling pathways that induced the changes observed. For example, subnetworks from HU-210 a ligand, that binds the cannabinoid receptors CB1R, are created to reach all transcription factors on the Panomics TFs array (see FIG. 5 for a network map containing all those subnetworks combined). These subnetworks are compared: the subnetworks to the transcription factors that showed enhanced activity vs. transcription factors that did not show change in activity. Components in each of those sets of subnetworks are counted where components that are enriched in those subnetworks that show enhanced activity are potential modulators of this activity and hence are potential drug targets and biomarkers specific for the input/perturbation/drug effects.

### METHOD B

Similarly to method A, method B measures the shortest path lengths (measured in steps), using for example Dijkstra's algorithm (Dijkstra 1959), between the list of components (nodes in the network) produced by the high-content experiments to reach all other components in the interaction data set (other intermediate components). These distances and their averages and standard deviations are compared to shortest path lengths reaching components from a controlled (may be randomly generated) list of components. Components that have statistically significant average shorter paths to the list of components shown to be changing (increasing or decreasing in activity or quantity) from the experiments are likely to be involved in the regulation, modulation and function of these components. Statistical significance can be determined similarly to what is described above for method A.

For example, this approach can be used to analyze Panomics TFs arrays experimental data results (U.S. Pat. No. 6,924,113, U.S. Pat. No. 6,821,737, Li et al. 2006) where a list of consensus sequences and their known transcription factors showing enhanced activity after cell stimulation are compared to a randomly generated list of consensus sequences and their known transcription factors that did not show change in activity. The method uses an interaction data set to measure the average shortest path-lengths from all components in the interaction data set to the transcription factors that changed and to those which did not change. Those network components that show statistically average short path lengths to the list of transcription factors that changed are potential modulators of the activity of these sets of transcription factors and hence are potential drug targets and biomarkers specific for the input/perturbation/drug effects.

### METHOD C

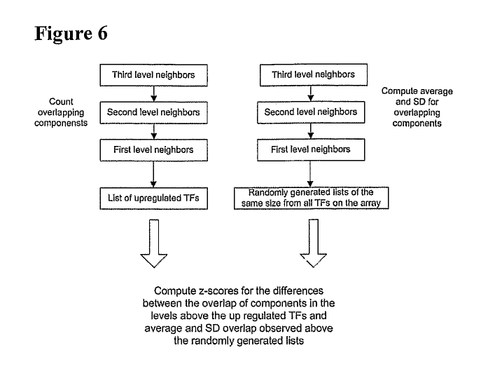

Similarly to methods A and B, method C expands interactions and components, using the interaction data sets, in steps upstream from the list of components produced by the experiments (the components shown to change in activity level). The method constructs arrays of components at hierarchical levels from the list of components (i.e. all first neighbors are stored in an array or a list for level 1 etc.). Each component in each level contains a counter that maintains the counts for the number of times it is connected to components from adjacent levels. The method searches for overlapping components and interactions in the first, second, third levels and so on (see FIG. 6 for a schematic representation of this concept). The counters for each component in each level are then compared to the counters of components found in levels created for a control list. Statistical significance of overlapping components, that are potentially regulators of the list of components produced by the experiments, can be determined similarly to what is described in method A.

For example, this approach can be used to analyze Panomics TFs arrays experimental data results (U.S. Pat. No. 6,924,113, U.S. Pat. No. 6,821,737, Li et al. 2006) where a list of consensus sequences and their known transcription factors showing enhanced activity after cell stimulation are compared to randomly generated lists of consensus sequences and their known transcription factors that did not show change in activity. The method uses an interaction data set containing all first level neighbors, second level neighbors and so on for the transcription factors matching the consensus sequences. The components in each of those sets levels that are enriched as neighbors to the transcription factors that showed enhanced activity are potential modulators of this activity and hence are potential drug targets and biomarkers specific for the input/perturbation/drug effects.

### EXAMPLE 5

### Method for Finding Circular Network Motifs

In this embodiment, feedback loops and all other types of network motifs are identified using an original method. Other systems that find and compute the statistical significance of network motifs and subgraphs using different computational methods exist, For example, the MFinder program (Kashtan N., Itzkovitz S., Milo R., Alon U. (2004) Efficient sampling algorithm for estimating subgraph concentrations and detecting network motifs. Bioinformatics 20, 1746-1758). The method in this application recursively expands nodes in the neighborhood of the current node and searches this way until a loop, a target node, or a limited depth was found or reached. A pseudo-code of the implementation of such method (algorithm) is listed below. This specific pseudo-code is written for the specific example of identification of cycles. The code could be easily modified by a person skilled in the art for identifying subnetworks from sources to targets as described in the third embodiment, cycles with Euclidian distance restriction, and any other type of network motif (Kashtan N., Itzkovitz S., Milo R., Alon U. (2004) Efficient sampling algorithm for estimating subgraph concentrations and detecting network motifs. Bioinformatics 20, 1746-1758).

function EXPAND (sourceNode, tempNode, sizeOfLoop, recursionDeptli, listSoFar)

{

| | |
|---|---|
| inputs: | sourceNode, the node we started with |

tempNode, the current node we are pointing to
sizeOfLoop, size of loop we look for
recursionDepth, the depth of the recursive calls
listSoFar, nodes we passed through so far

if (recursionDepth = sizeOfLoop) {

if (tempNode = sourceNode) {

AddToLinkListOfMotifs(listSoFar)

}

}
else if ( not ((recursionDepth > 1) and (tempNode = sourceNode))) {

for i 0 to tempNode.linksCount do {
localNode GET-NODE-BASED-ON-NUMBER
(tempNode.linksTo[i])
if NOT-ALREADY-IN-LIST(listSoFar, recursionDepth,
localNode)
and DIRECTION-OK(tempNode, localNode) and
(localNode.number <=

sourceNode.number) {

listSoFar[recursionDepth − 1 localNode
if (ProbabilityFunction(sizeOfLoop))

EXPAND (sourceNode, localNode,
sizeOfLoop, recursionDepth + 1, listSoFar)

}

}

}

}

### EXAMPLE 6

### Parallelization of All Subnetwork Identification and Network Motifs Finding Methods

Since the sub-graph search problem is an NP-hard (non-deterministic polynomial-time hard) problem (Garey and Johnson, 1979) the time it takes for running graph-traversal methods as described is computationally expensive. The use of recursion for traversing the network was found to be a speed enhancement alternative to the method used (Kashtan N., Itzkovitz S., Milo R., Alon U. (2004) Efficient sampling algorithm for estimating subgraph concentrations and detecting network motifs. Bioinformatics 20, 1746-1758.) and was implemented by others for other applications (e.g. U.S. Pat. No. 6,434,590). Another advantage of the above suggested implementations of the methods that can help in the NP-hardness of implementing such methods is that all methods that search, find, count, and classify subnetworks and network motifs can be easily parallelized by dividing the job. The traversal of the network for the purpose of searching the network can be performed in parallel by starting the search at a specific network components assigned to different specific computing nodes (on cluster platforms) and collecting the counts, found subnetworks and found network motifs at a master node through a remote communication interface (e.g. message passing interface (MPI)). All the methods described above in the embodiments of this application above are derivatives of the same recursive method following the pseudo-code disclosed above and thus share the property of being naturally parallelizable as described in this paragraph. This parallelization process is trivial for a person skilled in the art.

Details of the invention are described below, including specific examples. These examples are provided to illustrate embodiments of the invention. However, the invention is not limited to the particular embodiments, and many modifications and variations of the invention will be apparent to those skilled in the art. Such modifications and variations are also part of the invention.

### EXAMPLE 7

### Maps of the Regulatory Features of the Neuronal Cellular Network

According to the invention, the analyses are utilized to develop initial maps of the dynamic regulatory topology as signals from extracellular ligands traverse through the cellular network. To generate such maps boundaries are defined at the extracellular ligands and the cellular machines (effectors). The steps are used as latitude markers for identifying regions of information within the cellular network. In the first type of maps, the dynamics of information processing downstream of ligand receptor interactions are represented. The density of motifs are calculated at each step downstream of the receptor as an indicator of the information processing capability at this functional location. For this, a termed “density of information processing” (DIP) is defined as

$${DIP}_{i} = ( \frac{{M}_{i} - {M}_{i - 1}}{{L}_{i} - {L}_{i - 1}} ) \qquad ( 1 )$$

where Mᵢ=FBL3ᵢ+FBL4ᵢ+FFL3ᵢ+FFL4ᵢ+BIFANᵢ

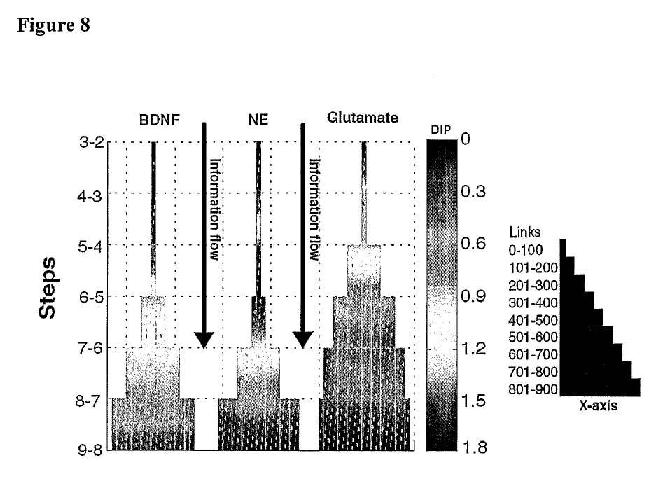

Mi is the total number of motifs. Li is the total links and i represents the step. FBL3 and FBL4 are feedback loops of size 3 and 4, FFL3 and FFL4 are feedforward loops of size 3 and 4 and BIFAN are bi-fan motifs of size 4. The DIP profile (FIG. 8) per step is plotted for the three different ligands through eight steps as signal propagates vectorially from receptors to cellular machines. It can be seen that the DIP profile for each of the three ligands is distinctive suggesting that these represent different connectivity's and regulatory configurations of these subnetworks representing different states of the activated network. All three ligands glutamate, NE and BDNF show a “hot zone” where extensive information processing occurs (Steps 6-5 for BDNF, 5-4 to 6-5 for NE, and 5-4 for glutamate). However the gradients of DIP to the “hot zones” and from the “hot zones” are different for the different ligands. Thus these maps can be used to identify the regions within the cell where information processing occurs when the cell is stimulated by a particular extracellular signal.

In a preferred embodiment, maps are developed to specify the location of the regulatory motifs. In this embodiment, the nodes are placed between extracellular ligands and cellular machines by specifying their locations on the basis of the shortest path lengths from the node to all extra-cellular ligands, as well as all components in the specified cellular machine. Next, a measure termed “location index” is calculated for each node. This index was calculated for all nodes as a measure of functional distance to each of the five cellular machines. The participation of these nodes in the various motifs is then identified. A parameter termed “motif location index” (MLI) is defined as the average of the location indices for the various nodes that comprise the motif in relationship to the distance from the specified machine. MLI can vary from 0 to 1 depending on its relative distance from the extracellular ligand to cellular machine, where 0 indicates location at the level of machines. MLI is calculated as follows:

$$MLI = \frac{{\sum }_{i = 1}^{n} ( \frac{{CPLM}_{i}}{{CPLM}_{i} + {CPLL}_{i}} )}{n} \qquad ( 2 )$$

where n is the size of the motif, CPLM is the characteristic path length from a node within the motif to all other nodes in the cellular machine and CPLL is the characteristic path length from a node to all extracellular ligands. If a node is an extracellular ligand then CPLL=0 for that node; if the node is in the plasma membrane CPLL=1. If a node belongs to a cellular machine, CPLM=0 for that node. The average shortest path length is computed using Floyd's algorithm (38).

### EXAMPLE 8

### Analysis of the Cellular Machine Maps

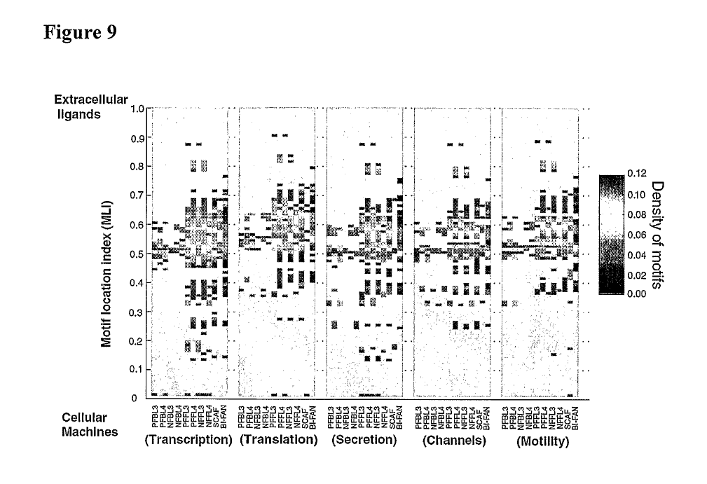

Five maps corresponding to the different cellular machines were generated (FIG. 9). These maps indicate the location of the various regulatory motifs between extracellular ligands and cellular machines. Both common and distinctive features are observed. When pathways from ligands to each of the cellular machines were considered, a higher density of regulatory motifs is found at the middle of the maps (note the band at motif location index 0.5 to 0.6, in the middle of the maps), indicating that a major portion of the information processing occurs at the center of the network.

Distinct patterns of motifs are observed upstream of the different cellular machines. Directly upstream of transcriptional machinery (0.1-0.4 MLI) feedforward motifs were abundant. In contrast for the translational machinery the regulation was more distal with only feedback loops being more abundant at 0.4 MLI. For the secretory machinery feedforward and feedback loops and scaffolds are observed from 0.15 to 0.4 MLI. For both the motility machinery and ion channels regulation is largely concentrated in the center of the network (around 0.5 MLI). These maps also show the presence of different regulatory motifs made of all components that are a part of a cellular machine. The transcriptional machine is abundant in positive feedback and feedforward motifs. This observation is consistent with the prevalence of feedforward loops that were previously shown in gene networks of lower organisms (11). The translation machinery also shows the presence of feedforward loops. Positive feedforward loops, as well as scaffolding motifs, are also present within the secretory apparatus. In the motility apparatus only scaffolding motifs are observed. Ion channels display noteworthy absence of motifs at the level of the machine. This is due to the lack of direct interactions between ion channels and the role of signaling components such as protein kinases in mediating interactions between channels.

The key findings from these analyses are: 1) Components of cellular signaling pathways and machines come together to form regulatory motifs such as feedback and feedforward loops. It is the presence of these motifs that allow the cell to process information from extracellular signals and decide when such information is transferred across time-scales; 2) Functional modularity within the cellular signaling network arises from the biologically specified binary connectivity and the number of steps required for a signal from a receptor to reach an effector; 3) Distinct patterns of regulatory motifs are formed in response to signals from different extracellular ligands. The balance of the emergent positive and negative motifs may define the capability of the ligand to induce plasticity or maintain homeostasis.

### Additional Information Related to the Methods of the Invention

Although this invention and application text has been primarily described as a method, a person skilled in the art can implement the methods of this invention using a computer. Similarly, a person of ordinary skill in the art can understand that there are other complex systems that are abstracted to networks and can be analyzed using the described methods.

In another embodiment, a process and a computer program is used to identify direct binary interactions of protein-protein or ligand-protein interactions. This process is unique in that it initially automatically searches and finds sentences that may describe direct cellular interactions for which immediate functional consequences are known. The user interface of the software allows the user to reject or accept interactions, link protein names to database identifiable numbers and store ontology on the same screen. The software has a learning algorithm that drives an internal process that recognizes previous entries to validate new components and interactions.

In another embodiment, a novel statistical analysis tool that partitions the network into subnetworks using biological function-based criteria is developed. Such networks are analyzed for information processing capability triggered by drug-target interactions during the propagation of signal through the network. Such analysis allows for the identification of distal relationships arising from long chains of binary links. Identification of these relationships can provide a molecular basis for predicting side effects of drug interactions based on the identifications of the various regulatory pathways that are involved.

In another embodiment, a visualization tool specific for regulatory cellular networks is developed. The software of the present invention uses the data from the process described in the first embodiment, and from other data sources to generate complete web-sites that contain the statistical characteristics of the network including the analysis described in the second embodiment, and navigation enabled connections maps from drugs to indirect targets.

In the fourth embodiment, modeling protocols and software that can rank components within the cell as targets for drugs that regulate complex cellular processes is developed. These modeling protocols can also be utilized to predict potential side effects of drugs based on sustained engagement of distal connections. A flowchart outlining this method is shown in FIG. 7. Two approaches are used to develop such predictions.

First, the graph theory statistical analysis used in the second embodiment is integrated with differential equations-based modeling to obtain quantitative input-output relationships when signal flows through the subnetworks capable of processing information. Analysis of the dependence of the input-output relationships on individual components within the subnetworks is then used to rank drug targets for efficacy in affecting cellular processes. Progressive juxtapositioning of the subnetworks to yield larger networks is used to uncover distal input-output relationships that can form the basis for unanticipated side-effects. Second, the present invention provides for a method that uses the networks developed in the first embodiment, as well as high throughput experimental results of time-course data (such as the phosphorylation states of key nodes in the network) to verify the dynamic topology of the network and thus rank individual components as suitable targets for drug action to regulate specified cellular processes. For this a machine-learning algorithm is applied to “train” the network to behave in a way that matches the experimental time-course data. This process produces a “trained” network. The resulting network can be then simulated with “drugs” that affect different nodes within the network. Nodes, which when perturbed by the drugs, produce desired and physiologically appropriate perturbations of network behavior can be further evaluated as drug targets. In this process we use an evolutionary algorithm to change certain properties of the network prior to each simulation cycle to better match the experimental results. Preferably each interaction is assigned a weight. The weight is an integer value initially drawn at random. The simulation is started by assigning each node zero tokens except the stimulus input nodes which are assigned one token. The simulation is then starting where in each cycle every node is visited and tokens pass from source nodes to target nodes based on the weights of the interactions. Interaction weights may be modified based on their past usage in previous simulation cycles. Once the simulation is completed, i.e. network connectivity has been running for n cycles, a distance function measures the distance between the results produced by the simulation, and the observed results from the time-course experiments. The goal of the iterative exercise is to minimize this distance. When further minimization is not possible, the network can be considered as experimentally constrained and used for perturbation analysis to rank drug targets and identify side effects.

By the term “interaction”, is meant the binding, activation, inhibition, upregulation, downregulation or contact by one entity with a second entity. In preferred embodiments the entities will either be small molecule ligands or biomolecules such as protein, DNA, RNA, lipid or lipid membranes, ions, nucleotide or other second messengers, or drugs.

By the term “interaction data” is meant data describing the interaction between two components. This may include, but is not limited to, identifiers, such as names or codes describing the interacting components, the nature or effect of the interaction, such as activation or inhibition and type of interaction such as phosphorylation or any biologically defined function, a descriptor identifying an interaction as being +, −, or 0, or a definition of an entity in 3-dimensional space.

By the term “dynamically connected” or “dynamically connected networks” is meant a network in which the nodes, are composed of both functional and non-functional links or interactions. In the case of a network of interconnected networks, the interconnecting networks are composed of either functional or non-functional links or connections.

By the term “non-therapeutic target” is meant the component of a biological system whose modulation by the drug, either directly or through additional components, is responsible for an effect that is not recognized as the desired therapeutic effect of the drug. The biological effect obtained by modulating this target with the drug may be either a desired or undesired biological effect.

By the term “side-effect” is meant the component of a biological system whose modulation by the drug, either directly or through additional components, is responsible for an undesired or non-therapeutic effect of the drug candidate.

A “nucleic acid molecule” refers to the phosphate ester polymeric form of ribonucleosides (adenosine, guanosine, uridine or cytidine; “RNA molecules”) or deoxyribonucleosides (deoxyadenosine, deoxyguanosine, deoxythymidine, or deoxycytidine; “DNA molecules”), or any phosphoester analogs thereof, such as phosphorothioates and thioesters, in either single stranded form, or a double-stranded helix. Double stranded DNA-DNA, DNA-RNA and RNA-RNA helices are possible. The term nucleic acid molecule, and in particular DNA or RNA molecule, refers only to the primary and secondary structure of the molecule, and does not limit it to any particular tertiary forms. Thus, this term includes double-stranded DNA found, inter alia, in linear (e.g., restriction fragments) or circular DNA molecules, plasmids, and chromosomes. In discussing the structure of particular double- stranded DNA molecules, sequences may be described according to the normal convention of giving only the sequence in the 5′ to 3′ direction along the nontranscribed strand of DNA (i.e., the strand having a sequence homologous to the mRNA). A “recombinant DNA molecule” is a DNA molecule that has undergone a molecular biological manipulation.

A “polynucleotide” or “nucleotide sequence” is a series of nucleotide bases (also called “nucleotides”) in a nucleic acid, such as DNA and RNA, and means any chain of two or more nucleotides. A nucleotide sequence typically carries genetic information, including the information used by cellular machinery to make proteins and enzymes. These terms include double or single stranded genomic and cDNA, RNA, any synthetic and genetically manipulated polynucleotide, and both sense and anti-sense polynucleotide (although only sense stands are being represented herein). This includes single- and double-stranded molecules, i.e., DNA-DNA, DNA-RNA and RNA-RNA hybrids, as well as “protein nucleic acids” (PNA) formed by conjugating bases to an amino acid backbone. This also includes nucleic acids containing modified bases, for example thio-uracil, thio-guanine and fluoro-uracil. “Expression profile” refers to any description or measurement of one or more of the genes that are expressed by a cell, tissue, or organism under or in response to a particular condition. Expression profiles can identify genes that are up-regulated, down-regulated, or unaffected under particular conditions. Gene expression can be detected at the nucleic acid level or at the protein level. The expression profiling at the nucleic acid level can be accomplished using any available technology to measure gene transcript levels. For example, the method could employ in situ hybridization, Northern hybridization or hybridization to a nucleic acid microarray, such as an oligonucleotide microarray, or a cDNA microarray. Alternatively, the method could employ reverse transcriptase-polymerase chain reaction (RT-PCR) such as fluorescent dye-based quantitative real time PCR (TaqMan® PCR). Expression profiling at the protein level can be accomplished using any available technology to measure protein levels, e.g., using peptide-specific capture agent arrays (see, e.g., International PCT Publication No. WO 00/04389).

The term “microarray” refers generally to any ordered arrangement (e.g., on a surface or substrate) of different molecules, referred to herein as “probes.” Each different probe of an array is capable of specifically recognizing and/or binding to a particular molecule, which is referred to herein as its “target,” in the context of arrays. Examples of typical target molecules that can be detected using microarrays include mRNA transcripts, cDNA molecules, cRNA molecules, and proteins.

Microarrays are useful for simultaneously detecting the presence, absence and quantity of a plurality of different target molecules in a sample (such as an mRNA preparation isolated from a relevant cell, tissue, or organism, or a corresponding cDNA or cRNA preparation). The presence and quantity, or absence, of a probe's target molecule in a sample may be readily by analyzing whether (and how much of) a target has bound to a probe at a particular location on the surface or substrate.

The arrays according to the present invention are preferably nucleic acid arrays (also referred to herein as “transcript arrays” or “hybridization arrays”) that comprise a plurality of nucleic acid probes immobilized on a surface or substrate. The different nucleic acid probes are complementary to, and therefore can hybridize to, different target nucleic acid molecules in a sample. Thus, such probes can be used to simultaneously detect the presence and quantity of a plurality of different nucleic acid molecules in a sample, to determine the expression of a plurality of different genes, e.g., the presence and abundance of different mRNA molecules, or of nucleic acid molecules derived therefrom (for example, cDNA or cRNA).

There are two major types of microarray technology; spotted cDNA arrays and manufactured oligonucleotide arrays.

The term “detectable change” as used herein in relation to an expression level of a gene or gene product (e.g., PNPG1) means any statistically significant change and preferably at least a 1.5-fold change as measured by any available technique such as hybridization or quantitative PCR.

The term “modulator” refers to a compound that differentially affects the expression or activity of a gene or gene product (e.g., nucleic acid molecule or protein), for example, in response to a stimulus that normally activates or represses the expression or activity of that gene or gene product when compared to the expression or activity of the gene or gene product not contacted with the stimulus. In one embodiment, the gene and gene product the expression or activity of which is being modulated includes a gene, cDNA molecule or mRNA transcript that encodes a mammalian PNPG1 protein such as, e.g., a rat, mouse, companion animal, or human PNPG1 protein. Examples of modulators of the PNPG1-encoding nucleic acids of the present invention include without limitation antisense nucleic acids, ribozymes, and RNAi oligonucleotides.

An “agonist” is defined herein as a compound that interacts with (e.g., binds to) a nucleic acid molecule or protein, and promotes, enhances, stimulates or potentiates the biological expression or function of the nucleic acid molecule or protein.

By the term “known drug” is a molecule that is known to have a biological effect when administered to a cell organism or other biological system. The effect may be a modulator, agonist, antagonist, inhibitor, regulator or other similar effector of activity or function either of known or unknown mechanism.

The term “RNA interference” or “RNAi” refers to the ability of double stranded RNA (dsRNA) to suppress the expression of a specific gene of interest in a homology-dependent manner. It is currently believed that RNA interference acts post-transcriptionally by targeting mRNA molecules for degradation. RNA interference commonly involves the use of dsRNAs that are greater than 500 bp; however, it can also be mediated through small interfering RNAs (siRNAs) or small hairpin RNAs (shRNAs), which can be 10 or more nucleotides in length and are typically greater than 18 nucleotides in length. For reviews, see Bosner and Labouesse, Nature Cell Biol. 2000; 2: E31-E36 and Sharp and Zamore, Science 2000; 287: 2431-2433. The present invention exemplifies the use of dsRNAs designed on the basis of PNPG1-encoding nucleic acid molecules of the invention in RNA interference methods to specifically inhibit PNPG1 gene expression.

A biomolecule could be a protein, peptide or nucleic acid molecule, a lipid or lipid structure or other such known biologically active molecule.

### REFERENCES

Ma'ayan, et al., Formation of Regulatory Patterns During Signal Propagation in a Mammalian Cellular Network. Science 309 (5737): 1078-1083.
Jordan, et al., Signaling networks: the origins of cellular multitasking. Cell. 2000 Oct
Silke Dodel, J. Michael Herrmann and Theo Geisel, Functional connectivity by cross-correlation clustering, Neurocomputing, Volumes 44-46, June 2002, Pages 1065-1070.
Milo R., Shen-Orr S., Itzkovitz S., Kashtan N., Chklovskii D., Alon U. (2002) Network motifs: simple building blocks of complex networks. Science 298, 824-827
Watts D. J., Strogatz S. H. (1998) Collective dynamics of ‘small-world’ networks. Nature 393, 440-442
Rual J F, et al. Towards a proteome-scale map of the human protein-protein interaction network. Nature. 2005 Oct 20;437(7062):1173-8.
Kashtan N., Itzkovitz S., Milo R., Alon U. (2004) Efficient sampling algorithm for estimating subgraph concentrations and detecting network motifs. Bioinformatics 20, 1746-1758.
Thomas H. Cormen, Charles E. Leiserson, Ronald L. Rivest, and Clifford Stein. Introduction to Algorithms, Second Edition. MIT Press and McGraw-Hill, 2001. ISBN 0262032937. Section 22.3: Depth-first search, pp.540-549.
Garey M. R., Johnson D. S. (1979) Computers and Intractability: A Guide to the Theory of NP-Completeness. W. H. Freeman & Co., New York
Ideker T, Galitski T, Hood L. A new approach to decoding life: systems biology. Annu Rev Genomics Hum Genet. 2001;2:343-72.
H. Salgado, Gama-Castro, S., Peralta-Gil, M., Diaz-Peredo, E., Sanchez-Solano, F., Santos-Zavaleta, A., Martinez-Flores, I., Jimenez-Jacinto, V., Bonavides-Martinez, C., Segura-Salazar, J., Martinez-Antonio, A., Collado-Vides, J., Nucleic Acids Res. 34, D394 (2006).
White, et al., Phil. Trans. Royal Soc. London. Series B, Biol Scien. 314, 1 (1986).
Hall and Russell, Neurosci. 11, 1 (1991).
Nikitin, et al., Pathway studio the analysis and navigation of molecular networks. Bioinformatics Vol. 19 no. 16 2003 pages 2155-2157.
Li, et al., High throughput assays for analyzing transcription factors. Assay Drug Dev Technol. 2006 Jun;4(3):333-41.
Dijkstra, A note on two problems in connexion with graphs. In: Numerische Mathematik. 1 (1959), S. 269-271
1. Jordan, et al., Cell. 103, 193 (2000).
2. Schlessinger, Cell. 103, 211 (2000).
3. Neves, et al., Science. 296, 1636 (2002).
4. Bhalla, et al., Science. 283, 381 (1999).
5. Markevich, et al., J. Cell. Biol. 164, 353 (2004).
6. Bhalla, et al., Science. 297, 1018 (2002).
7. Iyengar, Science. 271, 461 (1996).
8. Blitzer, et al., Science. 280, 1940 (1998).
9. Lahav, et al., Nat. Genet. 36, 147 (2004).
10. Angeli, et al., Proc. Natl. Acad. Sci. U. S. A. 101, 1822 (2004).
11. Mangan, et al., J. Mol. Biol. 334, 197 (2003).
12. Mangan, et al., Proc. Natl. Acad. Sci. U. S. A. 100, 11980 (2003).
13. Barabasi, et al., Nat. Rev. Genet. 5, 101 (2004).
14. Watts, et al., Nature. 393, 440 (1998).
15. Caldarelli, et al. European Physical Journal B. 38, 183 (2004)
16. Jeong, et al., Nature. 407, 651 (2000).
17. Milo, et al., Science. 298, 824 (2002).
18. Ravasz, et al., Science. 297, 1551 (2002).
19. Rosenfeld, et al., J. Mol. Biol. 329, 645 (2003).
20. Bliss, et al., Nature. 361, 31 (1993).
21. Siegelbaum, et al., Curr. Opin. Neurobiol. 1, 113 (1992).
23. Gough, et al., Sci. STKE. 2002, EG8, (2002).
25. Amaral, et al., Proc. Natl. Acad. Sci. U. S. A. 97, 11149 (2000).
26. Barabasi, et al. Science. 286:509 (1999).
27. Kashtan, et al., Bioinformatics. 20, 1746 (2004).
30. 0. Hvalby, J. C. Lacaille, G. Y. Hu, et al., Experientia. 43, 599 (1987).
31. H. Katsuki, Y. Izumi, C. F. Zorumski, J. Neurophysiol. 77, 3013 (1997).
32. H. Kang, E. M. Schuman, Science. 267, 1658 (1995).
35. Nguyen, T. Abel, E. R. Kandel, Science. 265, 1104 (1994).
36. Zakharenko, S. L. Patterson, I. Dragatsis, et al., Neuron. 39, 975 (2003).
37. Kovalchuk, E. Hanse, K. W. Kafitz, et al., Science. 295, 1729 (2002).
38. Cormen, C. E. Lieserson, R. L. Rivest, et al. 2002, Introduction to Algorithms, MIT Press Cambridge, Mass.
39. Genoux, U. Haditsch, M. Knobloch, et al., Nature. 418, 970 (2002).
40. Xiong, J. E. Ferrell, Nature. 426, 460 (2003).
41. Bourtchuladze, B. Frenguelli, J. Blendy, et al., Cell. 79, 59 (1994).
42. Prinz AA, D. Bucher, E. Marder Nature Neuroscience 7:1345 (2004).

The present invention is not to be limited in scope by the specific embodiments described herein. Indeed, various modifications of the invention in addition to those described herein will become apparent to those skilled in the art from the foregoing description and the accompanying figures. Such modifications are intended to fall within the scope of the appended claims.

It is further to be understood that all values are approximate, and are provided for description.

Patents, patent applications, publications, product descriptions, and protocols are cited throughout this application, the disclosures of which are incorporated herein by reference in their entireties for all purposes.

What is claimed is:

1. A method for identifying and ranking new drug targets for a known drug from an interaction data set which comprises
a) collecting a plurality of information units, each of said units containing biochemical data describing an interaction between two interacting molecules,
b) constructing an interaction data set from said collected information units, in which each of said molecules represents a node and said interaction between said interacting molecules represents a link between two nodes,
c) storing the interaction data set in an extractable form,
d) selecting from the interaction data set a list of nodes shown to be altered in a cell upon treatment with said known drug as an algorithmic starting point,
e) applying one or more graph theory based algorithms to the interaction data set using each node in the selected list of nodes as a starting point to identify a new list of nodes, connected to each node in the selected list, through any number of interconnected nodes,
f) compiling the number of instances in which each node appears in the new list of nodes, and
g) selecting as drug targets those molecules corresponding to nodes with the highest number of instances.

2. The method of claim 1 wherein creating a list of algorithmic starting points comprises
i) obtaining experimental data from an experiment where the known drug was administered,
ii) obtaining experimental data from an experiment where the known drug was not administered, and
iii) creating a list of biomolecules that have an observable change when comparing the results of the experiment in step (i) with the experiment in step (ii).

3. The method of claim 1 which comprises collecting the information units from published literature.

4. The method of claim 1 which comprises collecting the information units from experimental data.

5. The method of claim 1 which comprises generating at least one visual or textual representation of the interaction data for the list of nodes derived from the algorithmic analysis.

6. The method of claim 1 wherein the interaction data set comprises interactions from a cellular signal transduction pathway.

7. The method of claim 1 wherein the interaction data set comprises interactions from a cellular metabolic pathway.

8. The method of claim 1 wherein the interacting molecules comprise peptides, proteins or nucleic acids.

9. The method of claim 1 wherein said list of nodes connected to the selected node is a list of potential non-therapeutic targets of said known drug.

10. The method of claim 9 wherein the non-therapeutic target is a side-effect of the known drug.

11. The method of claim 1 which comprises storing the interaction data set on a computer.

12. The method of claim 1 which comprises generating said visual or textual representations of the connectivity data on a computer.

13. The method of claim 1 which comprises performing the graph theory based algorithm on a computer.

14. The method of claim 13 wherein the graph theory based algorithm is a depth-first search algorithm.

15. A method for screening to find potential new drug targets for a known drug using an interaction data set which comprises
a) collecting a plurality of information units, each of said units containing biochemical data describing an interaction between two interacting molecules,
b) constructing an interaction data set from said collected information units, in which each of said molecules represents a node and said interaction between said interacting molecules represents a link between two nodes,
c) storing the interaction data set in an extractable form,
d) selecting from the information data set a node known to interact with said known drug as an algorithmic starting point,
e) applying one or more graph theory based algorithms to the interaction data set using the selected node as a starting point to identify a list of nodes connected to the selected node, through any number of interconnected nodes, and
f) comparing the number of interconnected nodes between the input node and each node from the list of nodes.
g) selecting as potential new drug targets those nodes having the lowest number of interconnected nodes.

16. The method of claim 15 wherein the information units are collected from published literature.

17. The method of claim 15 wherein the information units are collected from experimental data.

18. The method of claim 15 which comprises generating at least one visual or textual representation of the interaction data for the list of nodes derived from the algorithmic analysis.

19. The method of claim 15 wherein the interaction data set comprises interactions from a cellular signal transduction pathway.

20. The method of claim 15 wherein the interaction data set comprises interactions from a cellular metabolic pathway.

21. The method of claim 15 wherein the interacting molecules comprise peptides, proteins or nucleic acids.

22. The method of claim 15 wherein said list of nodes connected to the selected node is a list of potential non-therapeutic targets of said known drug.

23. The method of claim 22 wherein the non-therapeutic target is a side-effect of the known drug.

24. The method of claim 15 wherein the interaction data set is stored on a computer.

25. The method of claim 15 wherein generating visual or textual representations of the connectivity data is performed on a computer.

26. The method of claim 15 wherein the graph theory based algorithm is performed on a computer.

27. The method of claim 26 wherein the graph theory based algorithm is a depth-first search algorithm.
